(19) United States
(12) Patent Application Publication
(10) Pub. No.: US 2008/0170271 A1
(43) Pub. Date: Jul. 17, 2008

(54) IMAGE FORMING DEVICE TO EXECUTE SCAN-TO-EMAIL OPERATION, PROCESSING METHOD THEREOF, AND TERMINAL DEVICE TO RECEIVE THE EMAIL FROM THE IMAGE FORMING DEVICE

(75) Inventor: Joo-chul LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/965,041

(22) Filed: Dec. 27, 2007

(30) Foreign Application Priority Data
Jan. 11, 2007 (KR) 2007-3177

(51) Int. Cl. H04N 1/00; G06F 15/00

(52) U.S. Cl. 358/402; 358/1.15

(57) ABSTRACT

An image forming device to execute scan-to-email operation includes a scanning unit, a mail writing unit to generate a preview image of the image data scanned by the scanning unit, and to write an email including the generated preview image as a content; and an interface unit to transmit the generated email through a mail server to an external terminal device. The mail writing unit includes an interface area to process the image data in a mail content. Accordingly, an interface area is selected, the image data is managed according to the selected interface area.

### CROSS-REFERENCE TO RELATED APPLICATIONS

This application claims priority under 35 U.S.C. §119(a) from Korean Patent Application No. 2007-3177, filed on Jan. 11, 2007, in the Korean Intellectual Property Office, the contents of which are incorporated herein by reference in its entirety.

### BACKGROUND OF THE INVENTION

1. Field of the Invention

The present general inventive concept relates to an image forming device to execute scan-to-email operation, a terminal device to receive email from the image forming device, and a method of scan-to-email operation by the image forming device and the terminal device. More particularly, the present general inventive concept relates to an image forming device to transmit email carrying a preview image of scanned image data as a content, and a terminal device to receive the email, and method to execute a scan-to-email operation by the image forming device and the terminal device.

2. Description of the Related Art

Computer peripheral devices of various types have been developed and have come into wide use with development of electronic technology. An image forming device such as a scanner, a duplicator, a printer, or a multifunctional peripheral is the typical examples of the computer peripheral devices.

Recently, image forming device such as the scanner, the duplicator, and the multifunctional peripheral, having a scanning function, provides a scan-to-email operation, which transmits scanned image data to an external terminal device in the form of email.

FIG. 1 is a schematic diagram illustrating a general structure of a system to execute a scan-to-email operation. Referring to FIG. 1, a scan-to-email system may comprise an image forming device 10, a mail server 20, and a terminal device 30.

The image forming device 10 generates image data by scanning a document, generates an email with an attachment of the generated image data, transmits the email to the mail server 20, and requests to transmit the e-mail to a receiver having a specified mail address. Accordingly, the mail server 20 transmits email when the terminal device 30 of the specified e-mail address is connected.

FIG. 2 is a schematic diagram illustrating an email format transmitted from the conventional image forming device 10 of FIG. 1. If a user checks the email transmitted by using the terminal device 30, content of the email is displayed on a screen as illustrated in FIG. 2. Referring to FIG. 2, a simple message which informs a user of receiving the email is displayed in the mail content, and the image data such as ‘Scan 001.pdf’ is displayed in the form of an attachment. To check the content of the image data to be displayed, a user has to open the attachments. In a case that the plurality of image data are attached, a matter of opening separately the respective image data is generated.

If a size of the scanned image is so large as to exceed a capacity of the mail server 20, it is impossible to transmit the email. In this case, the image data is divided into a plurality of parts and the divided data are transmitted through a plurality of email parts. But, one or more email parts may not be transmitted appropriately, in which case a user cannot recognize the image content.

As the document is scanned at the image forming device 10, the scanned image data is stored at an internal or external memory of the image forming device 10. Accordingly, when a user using the terminal device 30 determines that unnecessary image data exist upon checking the content of the image data through the email, the user has to go to the image forming device 10 to delete the unnecessary image data.

### SUMMARY OF THE INVENTION

The present general inventive concept provides an image forming device, a method of processing a scan-to-email operation, and a terminal device to receive an email, in which the email including a preview image of image data as a content is generated, and transmitted so that a user can check easily a content of the image data, and a capacity used in the mail server can be reduced.

The present general inventive concept also provides an image forming device, a method of processing a scan-to-email operation to generate an email and to transmit the email, and a terminal device to receive the email of the scan-to-email operation, the email including a preview image and an interface area of image data in content, so that a user can process easily image data when checking an email.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming device including a scanning unit to execute a scanning operation, a mail writing unit to generate a preview image of the image data scanned by the scanning unit, and to write an email including the generated preview image as a content, and an interface unit to transmit the generated email through a mail server to an external terminal device.

The mail writing unit may write the email including an interface area to request processing of the image data represented by the preview image.

The image forming device may further include a control unit to process image data in a manner corresponding to a selected interface area, if the interface area is selected through the external terminal device.

If an interface area to request download is selected through the external terminal device, the control unit may transmit the image data corresponding to the selected interface area to the external terminal device.

The image forming device may further include a storage unit to store the image data scanned at the scanning unit, and wherein, if the interface area to request data delete is selected through the external terminal device, the control unit may delete the image data corresponding to the selected interface area from the storage unit.

The content of the email may include one or more preview images, one or more interface areas displayed on one side of the respective preview images, an interface area to download the entire image data represented by the preview image, and an interface area to delete the entire image data represented by the preview image.

The content of the email may further include at least one among a term of validity, a file name, a file format, of the image data which the preview image represents, an information message having an IP address of the image forming device, and the number of preview images.

The foregoing and/or other aspects and utilities of the present general inventive concept may also be achieved by providing a terminal device including a transmitting and receiving unit to receive an email including as a content a preview image of an image data scanned at an image forming device having scan-to-email operation and an interface area to request image processing of the preview image, a user interface unit to provide a selection function with respect to the received email, and if the email is selected, to display the email content, and a central processing unit to transmit a request signal corresponding to the selected interface area to the image forming device, if one of the interface area representing the entire or a part of the preview image is selected.

The foregoing and/or other aspects and utilities of the present general inventive concept may also be achieved by providing method of processing a scan-to-email operation, the method including executing a scanning operation, generating a preview image of the scanned image data, writing an email including the generated preview image, and transmitting the email through a mail server to an external terminal device.

The operation of writing may write an email including an interface area to request processing of the image data represented by the preview image as a content.

The method may further include receiving a request signal corresponding to the selected interface area if the interface area is selected from the external terminal device, and processing the image data in a manner corresponding to the received request signal.

The method of processing scan-to-email operation may further include receiving the request signal corresponding to the selected interface area, if the interface area to request a download is selected through the external terminal device, and transmitting the image data corresponding to the selected interface area to the external terminal device according to the received request signal.

The method of processing scan-to-email operation may further include storing the scanned image data; receiving the request signal corresponding to the selected interface area, if the interface area to request data delete is selected, and deleting the image data corresponding to the selected interface area among the stored image data according the received request signal.

The content of the email may include one or more preview images, one or more interface areas displayed on one side of the respective preview images, an interface area to download the entire image data represented by the preview image, and an interface area to delete the entire image data represented by the preview image.

The content of the email may further include at least one among a term of validity, a file name, a file format, of the image data which the preview image represents, an information message having an IP address of the image forming device, and the number of preview images.

The foregoing and/or other aspects and utilities of the present general inventive concept may also be achieved by providing an image forming device, including a scanning unit to execute a scanning operation, and a mail writing unit to generate a preview image of image data scanned by the scanning unit, and to write an email including the generated preview image as a content.

The image forming device may further include an interface unit to transmit the generated email through a mail server to an external terminal device.

The foregoing and/or other aspects and utilities of the present general inventive concept may also be achieved by providing a terminal device including a transmitting and receiving unit to receive an email including as a content a preview image of image data scanned at an image forming device having a scan-to-email operation, and a central processing unit to transmit a request signal to the image forming device to receive the image data corresponding to the preview image from the image forming device.

The email may include an interface area to select the preview image and to request image processing of the preview image.

The terminal device may further include a user interface unit to provide a selection function with respect to the received email, and the central processing unit may transmit the request signal to the image forming device according to the selection function, and may receive the image data corresponding to the preview image from the image forming device in response to the request signal.

The foregoing and/or other aspects and utilities of the present general inventive concept may also be achieved by providing a system including an image forming device to execute a scanning operation, to generate a preview image of image data scanned by the scanning unit, and to write an email including the generated preview image as a content, and a terminal device to receive the email including the preview image of the image data, and to transmit a request signal to the image forming device to receive the image data corresponding to the preview image from the image forming device.

The foregoing and/or other aspects and utilities of the present general inventive concept may also be achieved by providing a method of a terminal device, the method including receiving an email including as a content a preview image of image data scanned at an image forming device having a scan-to-email operation, and transmitting a request signal to the image forming device to receive the image data corresponding to the preview image from the image forming device.

The foregoing and/or other aspects and utilities of the present general inventive concept may also be achieved by providing a method of a system, the method including executing a scanning operation, generating a preview image of image data scanned by a scanning unit of an image forming device, and writing an email including the generated preview image as a content, and receiving the email including the preview image of the image data, and transmitting a request signal to the image forming device to receive the image data corresponding to the preview image from the image forming device.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic diagram illustrating a general conventional system having an image forming device to execute scan-to-email operation;

FIG. 2 is a schematic diagram illustrating an email format transmitted from a conventional image forming device;

FIGS. 3 and 4 are block diagrams illustrating an image forming device according to exemplary embodiments of the present general inventive concept;

FIG. 5 is a schematic diagram illustrating an image forming system having an image forming device to process an email according to exemplary embodiments of the present general inventive concept;

FIG. 6 is a block diagram illustrating a terminal device of the image forming system of FIG. 5;

FIG. 7 is a schematic diagram illustrating an example of an email transmitted from an image forming device according to an exemplary embodiment of the present general inventive concept; and

FIGS. 8 and 9 are flowcharts illustrating a method of processing a scan-to-email operation of an image forming device according to exemplary embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

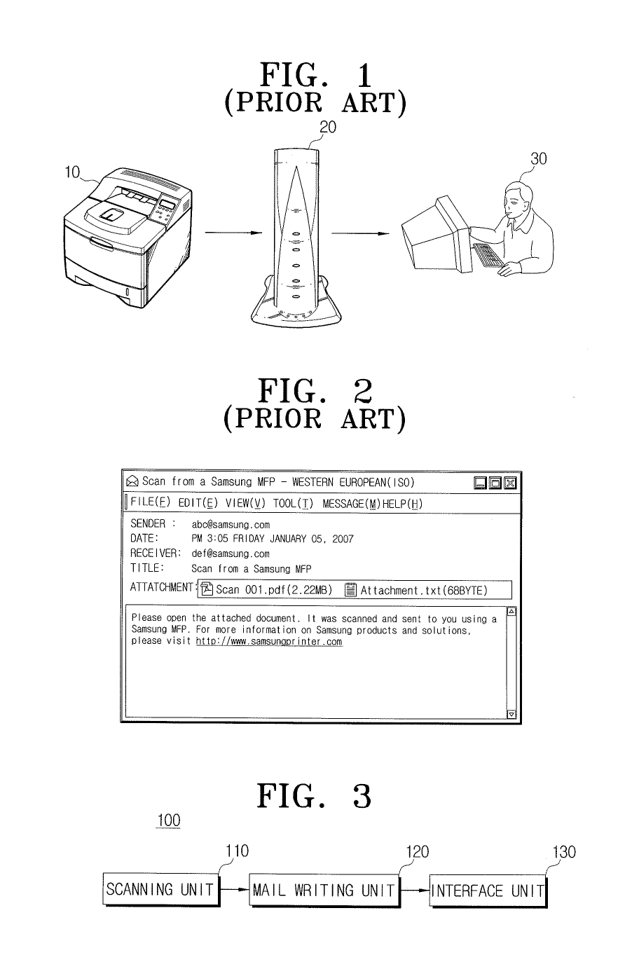

FIG. 3 is a block diagram illustrating an image forming device according to an exemplary embodiment of the present general inventive concept. Referring to FIG. 3, the image forming device may include a scanning unit 110, a mail writing unit 120, and an interface unit 130.

The scanning unit 110 scans a document and generates image data corresponding to the scanned document. That is, as a user puts the document on a document platen (not illustrated) and inputs a scanning command, the scanning unit 110 reads out content of the document by using a reading device such as charge coupled device (CCD). The image data is generated according to the readout content. The image data may be generated in various file formats such as pdf, bmp, or jpg.

If a scan-to-email operation is selected, the mail writing unit 120 generates a preview image of the generated image data, and writes an email including the generated preview image as a content. Upon selecting the scan-to-email operation, the user may input an intended receiver address by using an input device (not illustrated) of the image forming device such as a keypad, and a touch pad. The mail writing unit 120 may write the email by using the input data. The preview image of the generated image data may be represented as the mail content by using a web language such as HTML. If a plurality of pages of document are scanned, the preview image of each page may be generated respectively, and included in the content of one email. The input device may be a device to control the image forming device 10 through a wired or wireless connection.

The interface unit 130 transmits the generated email through an external mail server to an external terminal device (not illustrated). If a user using the external terminal device opens the email, the user can check readily the preview image of the scanned image data on the content. Accordingly, a user can check a plurality of the image data at once, and it is unnecessary to open attached files individually. The volume of the email is reduced because of transmitting the preview image instead of transmitting entire image data. As a result, a memory space used in the mail server 20 is reduced.

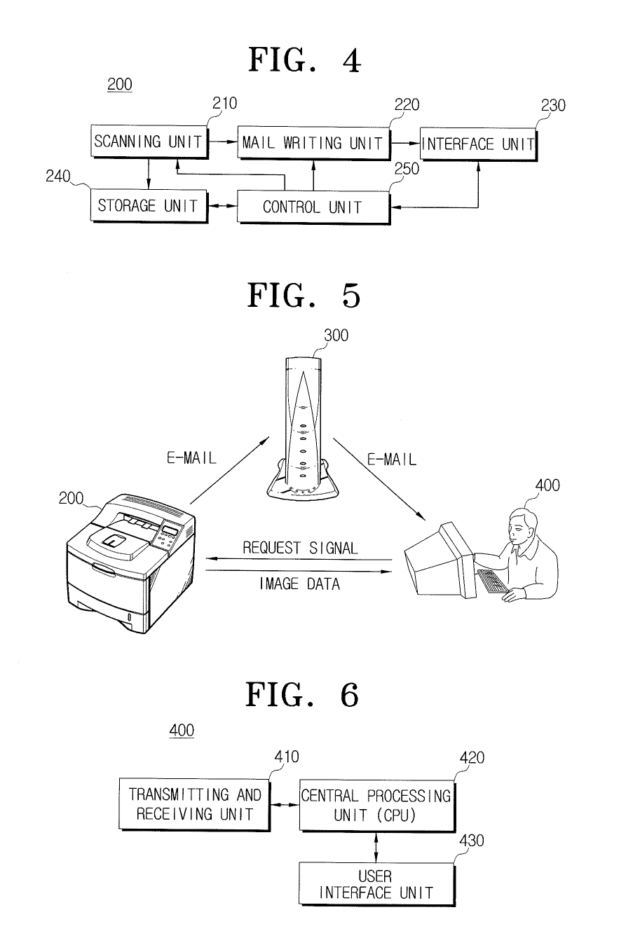

FIG. 4 is a block diagram illustrating an image forming device according to exemplary embodiments of the present general inventive concept. Referring to FIG. 4, an image forming device 200 may include a scanning unit 210, a mail writing unit 220, an interface unit 230, a storage unit 240, and a control unit 250.

The scanning unit 210 scans the document and generates the image data.

The scanned image data is stored at the storage unit 240. The storage unit 240 may be embodied as an interior memory of the image forming device 200, or an exterior memory such as an FTP server and a file server. The image data stored at the storage unit 240 is stored for a term of validity. A user can set the term of validity of the data by using the input device (not illustrated) when the user scans the document. The control unit 250 counts the time passed from time stored at the storage unit 240, and deletes the image data of which the validity is expired from the storage unit 240. A user may not set the time of validity to apply a default term to the control unit 250, and deletes the image data of which time of validity or default validity term is expired from the storage unit 240. Accordingly, the storage capacity of the image forming device 200 may be managed effectively.

The mail writing unit 220 generates the preview image of the generated image data, and writes the email including the generated preview image as a content. According to an aspect of the present general inventive concept, the mail writing unit 22 can include an interface area to request image processing in the email content.

Through the interface area, a user can select the content of the email using a mouse. For example, the interface area may include a link site and a mail address. If a user selects a link site area, the user is able to directly access a link site, and if the user selects a mail address part, a mail window to transmit the email to the specified mail address is displayed.

The interface areas included in the email content may be displayed respectively at one side of each preview image. The interface area may comprise a download interface area to download the image data which the preview image represents, a delete interface area to delete the image data which the preview image represents from the image forming device 200. Additionally, the interface area may include a download interface area to download the whole image data, and a delete interface area to delete the whole image data.

The interface unit 230 transmits the email written at the mail writing unit 220 through the mail server to an external terminal device.

A user of the external terminal device can open the email, and can check the content. Therefore, the user manages the image data in a manner that the user selects the interface area of the preview image which the user desires to download, or selects the interface area of the preview image which the user desires to delete. If the interface area is selected, a request signal, indicative of whether to download or delete the preview image, is transmitted to the image forming device 200.

The interface unit 230 receives a request signal and transmits the received signal to the control unit 250.

The control unit 250 processes the image data in response to the received request signal. For example, if a user selects the download interface area of a specific preview image, the download request signal is transmitted from the terminal device to the image forming device 200. The control unit 250 transmits the image data corresponding to the specific preview image to the terminal device, according to the request signal. That is, the control unit 250 configures a packet header by using the address of the terminal device included in the request signal, retrieves the image data stored at the storage unit 240 and configure a packet payload with the retrieved image data, and transmits the configured packet to the terminal device.

Meanwhile, if a user selects the delete interface area of a specific preview image, the delete request signal is transmitted from the terminal device to the image forming device 200. The control unit 250 deletes the image data corresponding to the specific preview image from the storage unit 240, according to the request signal.

Because the interface area to process the image is provided in the email content, a user can manage easily the image data on a user's own terminal device.

FIG. 5 is a schematic diagram illustrating an image forming system or a scan-to-email system having the image forming device 200 of FIG. 4. Referring to FIGS. 4 and 5, the system may include an image forming device 200, a mail server 300, and a terminal device 400 which communicate with each other through a wired or wireless connection.

The structure of the image forming device 200 is illustrated in FIG. 4. As explained in FIG. 4, the image forming device 200 writes the email to include the preview image and the interface area, and transmits the written email to the mail server 300.

If a user accesses an account of the mail server 300, the mail server 300 notifies the user of the reception of the email, and provides the email to the terminal device.

The user of the terminal device 400 opens the provided email, and checks the content. If the user selects the download interface area, a request signal to download the image data of the preview image is transmitted to the image forming device 200.

The image forming device 200 retrieves the requested image data according to the request signal among prestored data, and transmits the retrieved image data to the terminal device 400. Meanwhile, if the user selects the delete interface area, the request signal to delete the image data of the preview image is transmitted to the image forming device 200, and the image forming device 200 deletes the image data according to the request signal.

Although FIG. 5 illustrates that the request signal and the image data are transmitted between the image forming device 200 and the terminal device 400, it is possible that the request signal and the image data can be transmitted to the image forming device 200 and the terminal device 400 through the mail server 300.

FIG. 6 is a block diagram illustrating an example of the terminal device 400 applied to the system of FIG. 5. The terminal device 400 of FIG. 6 may include various types of devices, such as desktop PC, a laptop PC, a personal digital assistant (PDA), or a cell phone.

Referring to FIG. 6, the terminal device 400 includes a transmitting and receiving unit 410, a central processing unit (CPU) 420, and a user interface unit 430.

The transmitting and receiving unit 410 receives or transmits data from and to an external device, such as the mail server 300, and the image forming device 200.

The user interface unit 430 may include an input device (not illustrated) which inputs a signal selected by user, and a display device (not illustrated) to display the email content, so that the email can be opened.

When the email as explained above is received through the transmitting and receiving unit 410, and when a command to open the email is input through the user interface unit 430, the CPU 420 controls the user interface unit 430 to display the email.

If a specific interface area in the email content is selected, a request signal according to the selected interface area is transmitted to the image forming device 200. According to an aspect of the present general inventive concept, a destination address of the request signal may be determined by using information such as an IP address of the image forming device 200 received along with the email.

The CPU 420 transmits the request signal to download the image data, if the download interface area is selected. And if the image data corresponding to the request signal is received from the image forming device 200, the CPU 420 controls such that the received data is stored to a storage device (not illustrated).

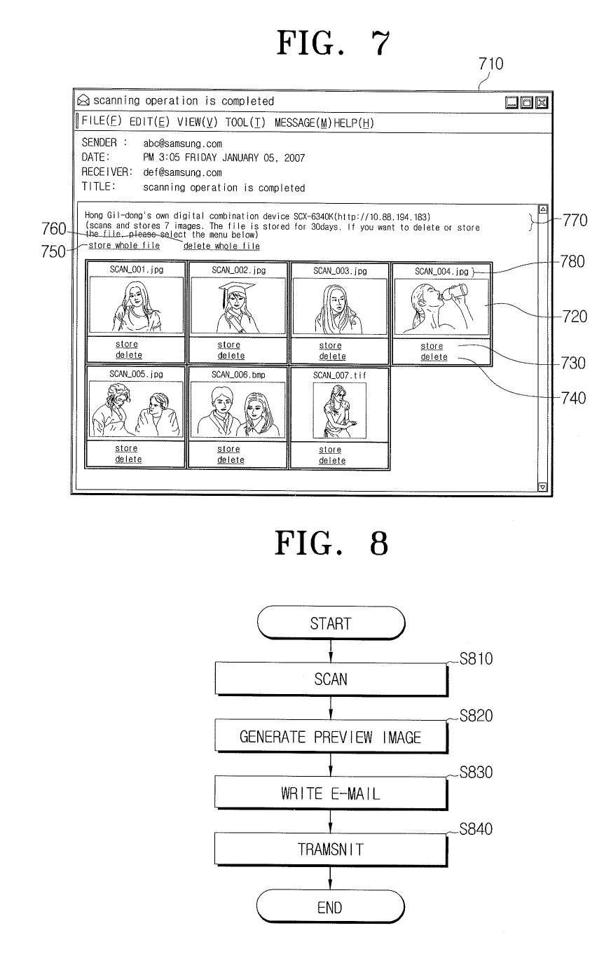

FIG. 7 is a schematic diagram illustrating an example of the email format written at an image forming device. Referring to FIG. 7, an email 710 comprises a preview image 720, a download interface area 730, a delete interface area 740, a whole file download interface area 750, a whole file delete interface area 760, a message area 770, and file information area 780 to indicate title or format of the file.

The preview image 720 is an image downscaled at a specified ratio to represent the scanned image data.

If pluralities of image data are generated, the plurality of preview images 720 are displayed as illustrated in FIG. 7.

The interface areas 730 and 740 to process the image data represented by the preview image 720 may be displayed in one side of the preview image 720.

Although FIG. 7 shows the “store” download interface area 730 and the “delete” delete interface area 740, these interface areas may be added or unnecessary interface area may be removed according to exemplary embodiments of the present general inventive concept. For example, “transmit to another terminal device”, “extend the term of validity”, or the like may be added as the interface area.

The file information area 780 may display a file name (SCAN_{—}001˜SCAN_{—}007), a file format (jpg, bmp, tif) of the image data which the preview image represents, at another side of the respective preview images 720.

At an upper part of the mail content, the message area 770 having the IP address (http://10.88.194.183) of the image forming device 200 transmitting the email, and a term of validity (e.g., 30 days) may be indicated.

As a result, a user can check information related to the scanned image, and manage the image data by using the various interface areas 730, 740, 750, and 760.

FIG. 8 is a flowchart illustrating a method of processing a scan-to-email operation of an image forming device according to exemplary embodiments of the present general inventive concept. Referring to FIGS. 5 and 8, in operation S810, a document is scanned at the image forming device 200, and in operation S820, a preview image of the scanned image data is generated.

In operation S830, an email including a preview image in web language such as HTML is written.

In operation S840, the written email is transmitted to the mail server 300.

The image forming device 200 requests the mail server 300 to transmit the email to a previously input email address, and a user using the external terminal device receives the email.

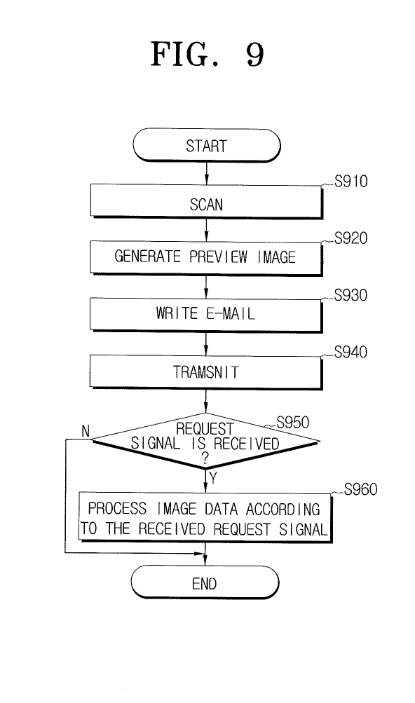

FIG. 9 is a flowchart illustrating a method of processing a scan-to-email operation of an image forming device according to another exemplary embodiment of the present general inventive concept.

Referring to FIGS. 3 and 9, in operation S910, image data is generated by scanning, in operation S920, the image forming device 200 generates a preview image representing the image data, in operation S930, the image forming device 200 writes, composes, or generates an email including the generated preview image, and in operation S940, the image forming device 200 transmits the written email to an external terminal device through the mail server 300.

A user of the external terminal device checks the email received through the mail server 300, and selects the interface area indicated in the email content. If the interface area is selected, a request signal corresponding to the selected interface area is transmitted to the image forming device 200.

In operation S950, a request signal is received, and in operation S960, the image forming device 200 processes the image data in response to the received request signal. If a download is requested, the image forming device 200 transmits the image data to the external terminal device, and if a delete is requested, the image forming device 200 deletes the image data. If a request signal of other operation is received, the image forming device 200 executes the process according to the command. As a result, a user of the external terminal device can manage easily the image data scanned at the image forming device.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the image forming device according to exemplary embodiments of the present general inventive concept transmits an email including the generated the preview image so that a user can check easily the content of the image data, and requirement for capacity of the mail server is reduced. Also, a user can manage easily the image data in the process of checking the email, because the email includes the interface area and the preview image of the image data. As a result, inconvenience of user is avoided, and requirement for capacity of the mail server is reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device, comprising:
a scanning unit to execute a scanning operation; and
a mail writing unit to generate a preview image of image data scanned by the scanning unit, and to write an email including the generated preview image as a content

2. The image forming device of claim 1, further comprising:
an interface unit to transmit the generated email through a mail server to an external terminal device.

3. The image forming device of claim 2, wherein the mail writing unit writes the email including in the content an interface area to request processing of the image data represented by the preview image.

4. The image forming device of claim 3, further comprising:
a control unit to process the image data in a manner corresponding to a selected interface area, if the interface area is selected through the external terminal device.

5. The image forming device of claim 4, wherein if an interface area to request download is selected through the external terminal device, the control unit transmits the image data corresponding to the selected interface area to the external terminal device.

6. The image forming device of claim 4, comprising:
a storage unit to store the image data scanned at the scanning unit, and
wherein, if the interface area to request data delete is selected through the external terminal device, the control unit deletes the image data corresponding to the selected interface area from the storage unit.

7. The image forming device of claim 1, wherein the content of the email comprises one or more preview images, one or more interface areas displayed on one side of the respective preview images, an interface area to download the entire image data represented by the preview image, and an interface area to delete the entire image data represented by the preview image.

8. The image forming device of claim 7, wherein the content of the email further comprises at least one among a term of validity, a file name, a file format, of the image data which the preview image represents, an information message having an IP address of the image forming device, and the number of preview images.

9. A terminal device comprising:
a transmitting and receiving unit to receive an email including as a content a preview image of image data scanned at an image forming device having a scan-to-email operation; and
a central processing unit to transmit a request signal to the image forming device to receive the image data corresponding to the preview image from the image forming device.

10. The terminal device of claim 9, wherein the email comprises an interface area to select the preview image and to request image processing of the preview image.

11. A system comprising:
an image forming device to execute a scanning operation, to generate a preview image of image data scanned by the scanning unit, and to write an email including the generated preview image as a content; and
a terminal device to receive the email including the preview image of the image data, and to transmit a request signal to the image forming device to receive the image data corresponding to the preview image from the image forming device.

12. A method of processing a scan-to-email comprising:
executing a scanning operation;
generating a preview image of the scanned image data; and
writing an email including the generated preview image as a content.

13. The method of claim 12, further comprising:
transmitting the email through a mail server to an external terminal device.

14. The method of claim 12, wherein the operation of writing an the email comprises writing an email including an interface area to request processing of the image data represented by the preview image as a content.

15. The method of claim 13, further comprising:
receiving a request signal corresponding to the selected interface area, if the interface area is selected from the external terminal device; and
processing the image data in a manner corresponding to the received request signal.

16. The method of claim 13, further comprising:
receiving the request signal corresponding to the selected interface area, if the interface area to request a download is selected at the external terminal device; and
transmitting the image data corresponding to the selected interface area to the external terminal device according to the received request signal.

17. The method of claim 13, further comprising:
storing the scanned image data;
receiving the request signal corresponding to the selected interface part, if the interface area to request data delete is selected; and
deleting the image data corresponding to the selected interface area among the stored image data according the received request signal.

18. The method of claim 12, wherein the content of the email comprises one or more preview images, one or more interface areas displayed on one side of the respective preview images, an interface area to download the entire image data represented by the preview image, and an interface area to delete the entire image data represented by the preview image.

19. The method of claim 18, wherein the content of the email further comprises at least one among a term of validity, a file name, a file format, of the image data which the preview image represents, an information message having an IP address of the image forming device, and the number of preview images.

21. A method of a system, the method comprising:
executing a scanning operation, generating a preview image of image data scanned by a scanning unit of an image forming device, and writing an email including the generated preview image as a content; and
receiving the email including the preview image of the image data, and transmitting a request signal to the image forming device to receive the image data corresponding to the preview image from the image forming device.
